(19) United States
(12) Patent Application Publication
(10) Pub. No.: US 2026/0034494 A1
(43) Pub. Date: Feb. 5, 2026

(54) AIR COMPRESSOR FILTER

(71) Applicant: Hongda ZHENG, Leqing (CN)

(72) Inventor: Hongda ZHENG, Leqing (CN)

(73) Assignee: Zhejiang Nan Pu Pneumatic Component Co., Ltd., Leqing (CN)

(21) Appl. No.: 19/354,818

(22) Filed: Oct. 9, 2025

(30) Foreign Application Priority Data
Sep. 25, 2025 (CN) 202511384225.6

(51) Int. Cl. B01D 46/62; B01D 46/10; B01D 46/30

(52) U.S. Cl. CPC B01D 46/62; B01D 46/10; B01D 46/30; B01D 2257/702; B01D 2257/80

(57) ABSTRACT

The present disclosure provided an air compressor filter, including a housing, a first filtration component, a second filtration component, a silicone filtration component, and an activated carbon filtration component. The housing is provided with an airflow passage, an airflow inlet, and an airflow outlet in communication with the airflow passage. The first filtration component, second filtration component, silicone filtration component, and activated carbon filtration component are sequentially connected to the housing and communicate with the airflow passage. Airflow enters the airflow passage through the airflow inlet and flows through the first filtration component, second filtration component, silicone filtration component, and activated carbon filtration component in sequence, eventually exiting through the airflow outlet. The silicone filtration component is equipped with a space for holding the color-changing silicone.

### CROSS-REFERENCE TO RELATED APPLICATIONS

The application claims priority of Chinese patent application CN 2025113842256, filed on Sep. 25, 2025, which is incorporated herein by reference in its entireties.

### TECHNICAL FIELD

The present disclosure relates to the field of filtration devices, particularly to an air compressor filter.

### BACKGROUND OF THE INVENTION

Compressed air is widely used in various industrial fields, such as semiconductor manufacturing, electronics, machinery, chemical engineering, automotive, metallurgy, and furniture industries. This compressed air is generally produced by compressing atmospheric air using a compressor. However, the compressed air thus produced still contains impurities such as water, oil, and dust, which can significantly affect the product quality in various industries. In precision industries that require a clean environment, this type of compressed air does not meet the usage requirements. As a result, compressed air filters are commonly used to filter and remove impurities from the compressed air.

Existing air compressor filters typically employ multi-stage filtration structures to remove moisture, oil mist, particulate impurities, and harmful gases from compressed air. These filters mainly include oil-water separation components, fine filtration components, silica filtration components, and activated carbon filtration components. During use, these components need to be regularly replaced to ensure effective filtration. However, due to the varying usage frequency of products, regularly replacing these components does not guarantee their effectiveness. Specifically, it is difficult to accurately determine whether the silica filtration component has reached a saturated state. Premature replacement of the silica filtration component reduces production efficiency and increases production costs, while delayed replacement negatively impacts the filtration effect, resulting in ineffective water filtration.

In view of the above, the present disclosure provides an air compressor filter that effectively addresses these issues. It has a simple structure and, through a visual window, allows users to directly observe the saturation level of the silica filtration component, making it easier to timely replace the silica filtration component and other filtration components.

### SUMMARY OF THE INVENTION

In order to overcome the deficiencies of the prior art, the present disclosure provides an air compressor filter with a simple structure. It allows users to directly observe the saturation of the silica filtration component through a visual window, enabling timely replacement of the silica filtration component and other filtration components.

The technical solution adopted to solve the technical problem of the present disclosure is as follows:

An air compressor filter, including:

A housing, a first filtration component, a second filtration component, a silica filtration component, and an activated carbon filtration component, in which the housing is provided with an airflow passage and airflow inlet and outlet connected to the airflow passage;

The first filtration component, the second filtration component, the silica filtration component, and the activated carbon filtration component are sequentially connected to the housing and communicate with the airflow passage. Airflow enters the airflow passage through the airflow inlet, passing through the first filtration component, the second filtration component, the silica filtration component, and the activated carbon filtration component, and finally exits through the airflow outlet;

In which, the silica filtration component is provided with a holding space to contain color-changing silica. The surface of the silica filtration component is equipped with several observation windows, allowing users to observe the color-changing silica inside the holding space.

Beneficial Effects of the Invention are: Through the above structural design, during use, the airflow enters the airflow passage through the airflow inlet, then passes through the first filtration component for preliminary filtration to remove most of the water in the airflow, with the water remaining in the first filtration component. The airflow then exits, flowing through the airflow passage into the second filtration component. After further filtration, most of the oil in the airflow is removed, with the oil remaining in the second filtration component. The airflow then exits, flowing through the airflow passage into the silica filtration component. The color-changing silica in the silica filtration component absorbs water, further removing water from the airflow. At the same time, the color-changing silica changes color as it absorbs water. Users can observe the color of the color-changing silica through the observation windows to assess its saturation level. When the saturation level of the color-changing silica exceeds a preset value, the silica can be restored by heating or replaced, ensuring that the silica continues to absorb remaining water and indicate the moisture content in the airflow. This guarantees that the moisture content of the airflow passing through the silica filtration component is below the preset value. The airflow exits the silica filtration component, flows through the airflow passage, and enters the activated carbon filtration component. The activated carbon filter element in the activated carbon filtration component further adsorbs and filters the remaining oil vapors in the airflow. The clean airflow, filtered through multiple stages, exits to the airflow passage and finally flows out through the airflow outlet.

### BRIEF DESCRIPTION OF THE DRAWINGS

In order to more clearly illustrate the technical solutions in the embodiments of the present disclosure, the following provides a brief description of the drawings used in the embodiments. The drawings described below are merely some embodiments of the present disclosure. For those skilled in the art, other drawings may be derived from these without the need for inventive effort.

The present disclosure will be further explained with reference to the drawings and embodiments.

FIG. 1 illustrates a schematic diagram of the overall structure of the invention from one angle.

FIG. 2 illustrates a schematic diagram of the overall structure of the invention from another angle.

FIG. 3 illustrates an exploded view of the invention from one angle.

FIG. 4 illustrates an exploded view of the invention from another angle.

FIG. 5 illustrates an enlarged view of the area marked as A in FIG. 3.

FIG. 6 illustrates an enlarged view of the area marked as B in FIG. 4.

FIG. 7 illustrates a schematic diagram of the airflow direction in the invention.

FIG. 8 illustrates a cross-sectional view of the invention.

FIG. 9 illustrates an enlarged view of the area marked as C in FIG. 8.

FIG. 10 illustrates an enlarged view of the area marked as D in FIG. 8.

FIG. 11 illustrates a cross-sectional view of the invention when the automatic drainage function is activated and the liquid level in the first filtration chamber is below the preset value.

FIG. 12 illustrates a cross-sectional view of the invention when the automatic drainage function is activated and the liquid level in the first filtration chamber is above the preset value.

FIG. 13 illustrates a cross-sectional view of the invention during manual drainage.

FIG. 14 illustrates a partial schematic diagram of the automatic drainage component of the invention.

### DESCRIPTION OF EMBODIMENTS

To make the objectives, characteristics, and advantages of the present disclosure clearer and easier to understand, the following provides a detailed explanation of the specific embodiments of the application with reference to the accompanying drawings. The description below includes many specific details to facilitate a full understanding of the application. However, the application can be implemented in many ways other than those described here, and those skilled in the art may make similar improvements without deviating from the spirit of the application. Therefore, the application is not limited to the specific embodiments disclosed below.

In the description of this application, it should be understood that if the terms “center”, “longitudinal”, “transverse”, “length”, “width”, “thickness”, “up”, “down”, “front”, “back”, “left”, “right”, “vertical”, “horizontal”, “top”, “bottom”, “inner”, “outer”, “clockwise”, “counterclockwise”, “axial”, “radial”, “circumferential”, and others appear, the directional or positional relationships indicated by these terms are based on the orientation or positional relationship shown in the accompanying drawings. These terms are provided for the purpose of simplifying the description of the application and do not indicate or imply that the device or component referred to must have a specific orientation or be constructed and operated in a specific orientation, and should not be understood as limiting the application.

Furthermore, if terms such as “first” and “second” appear, these terms are used solely for the purpose of description and should not be understood as indicating or implying relative importance or implicitly specifying the number of features. Therefore, features labeled with “first” and “second” may explicitly or implicitly include at least one of the described features. In the description of this application, if the term “multiple” appears, it means at least two, such as two, three, and so on, unless explicitly specified otherwise.

In this application, unless otherwise explicitly specified, if terms such as “installed”, “connected”, “linked”, “fixed”, etc., appear, these terms should be understood broadly. For example, they can refer to fixed connections, detachable connections, or integral connections; mechanical connections or electrical connections; direct connections or indirect connections through intermediate mediums; connections within two elements or interaction relationships between two elements, unless otherwise explicitly specified. Those skilled in the art can understand the specific meaning of these terms in the context of this application based on the specific situation.

In this application, unless otherwise explicitly specified, if the description indicates that a first feature is “on”, “above”, or “below” a second feature, this can mean that the first and second features are in direct contact, or the first and second features are indirectly in contact through an intermediate medium. Additionally, if a first feature is described as being “above”, “upward”, or “on top” of a second feature, this may mean the first feature is directly above or diagonally above the second feature, or it simply indicates that the first feature is at a higher level than the second feature. If the first feature is described as being “below”, “downward”, or “underneath” the second feature, this may mean that the first feature is directly below or diagonally below the second feature, or it simply indicates that the first feature is at a lower level than the second feature.

It should be noted that if a component is described as being “fixed to” or “arranged on” another component, it may either be directly on the other component or may be located with an intermediate component. If a component is considered to be “connected” to another component, it may be directly connected to that component or may involve an intermediate component. The terms used in this application, such as “vertical”, “horizontal”, “up”, “down”, “left”, “right”, and similar expressions, are provided solely for illustrative purposes and do not imply that they are the only implementation options.

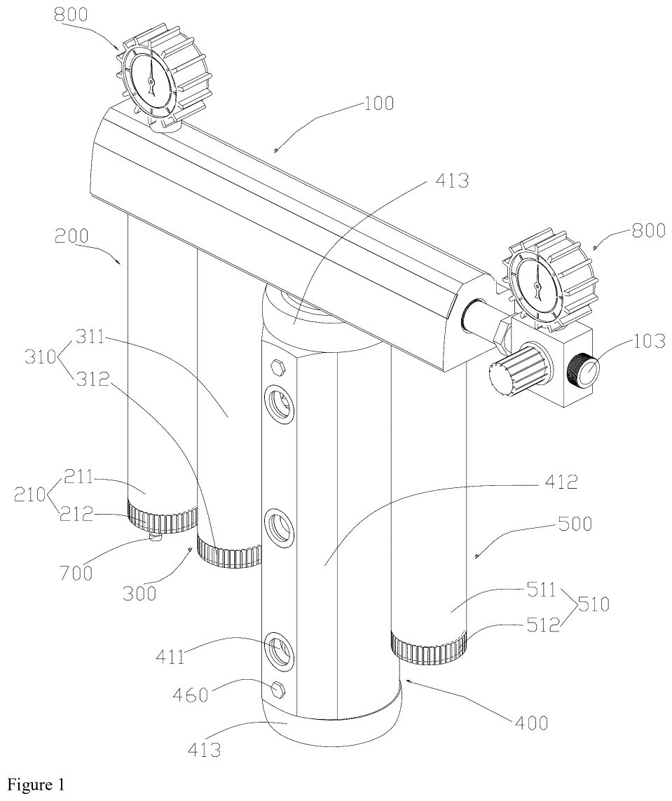

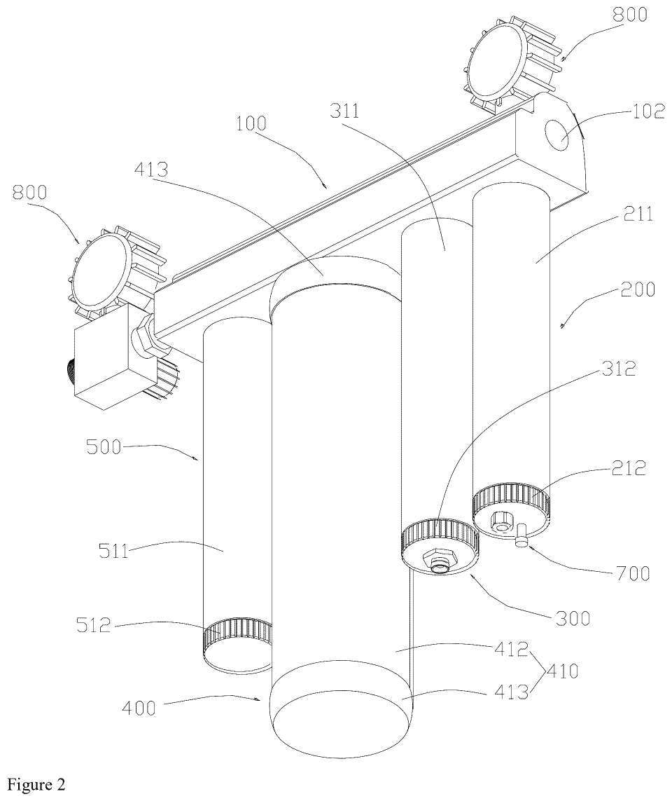

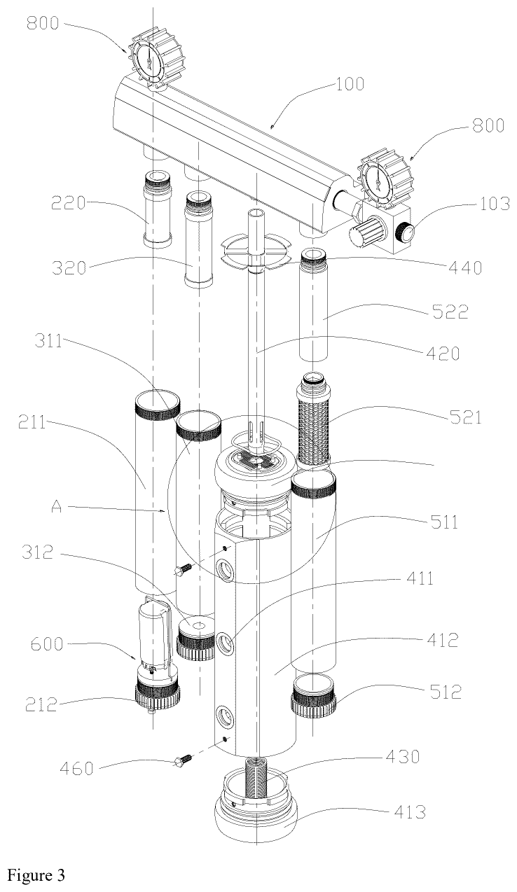

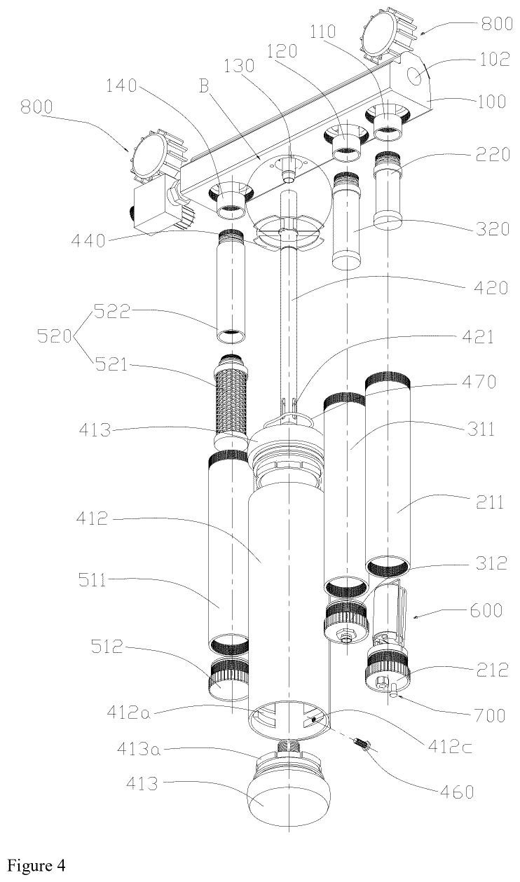

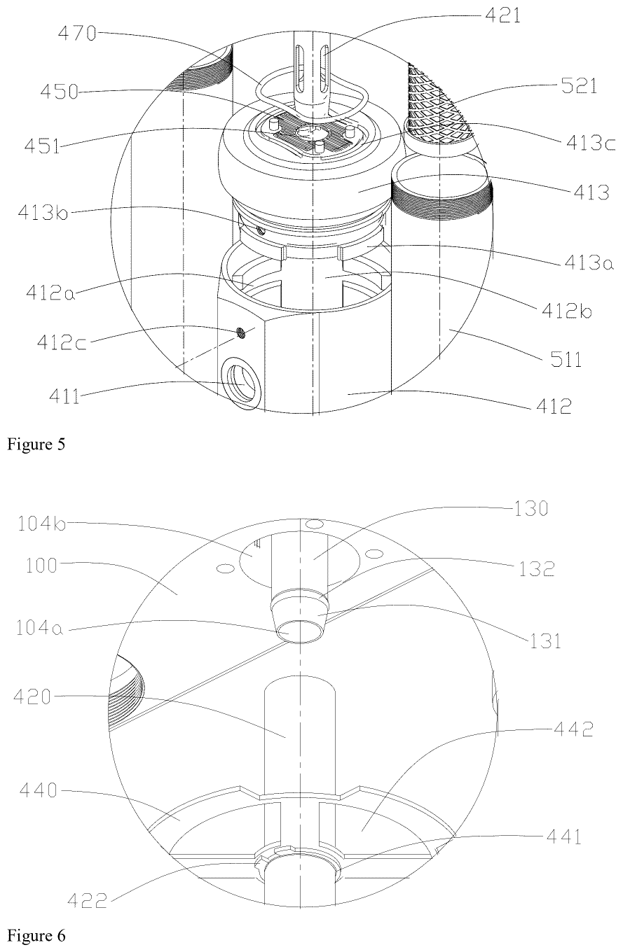

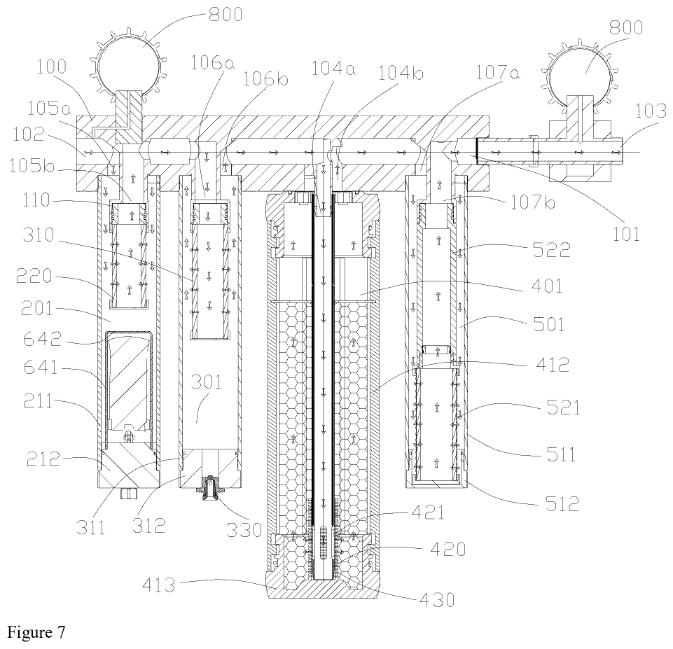

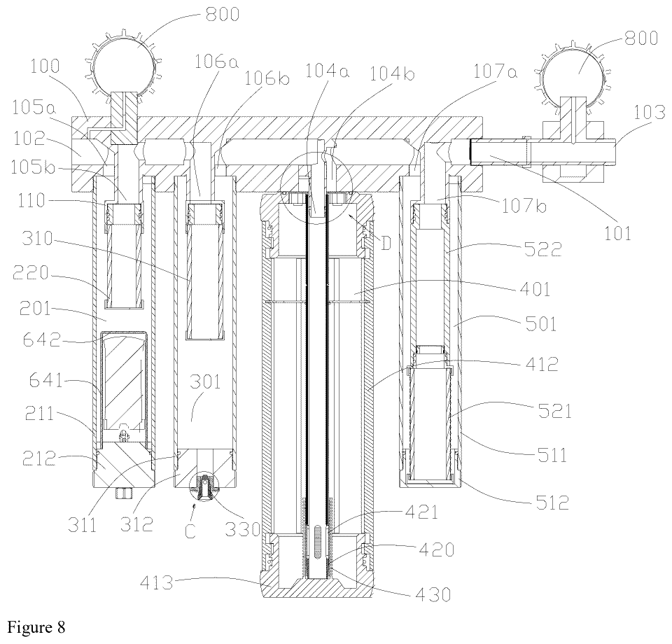

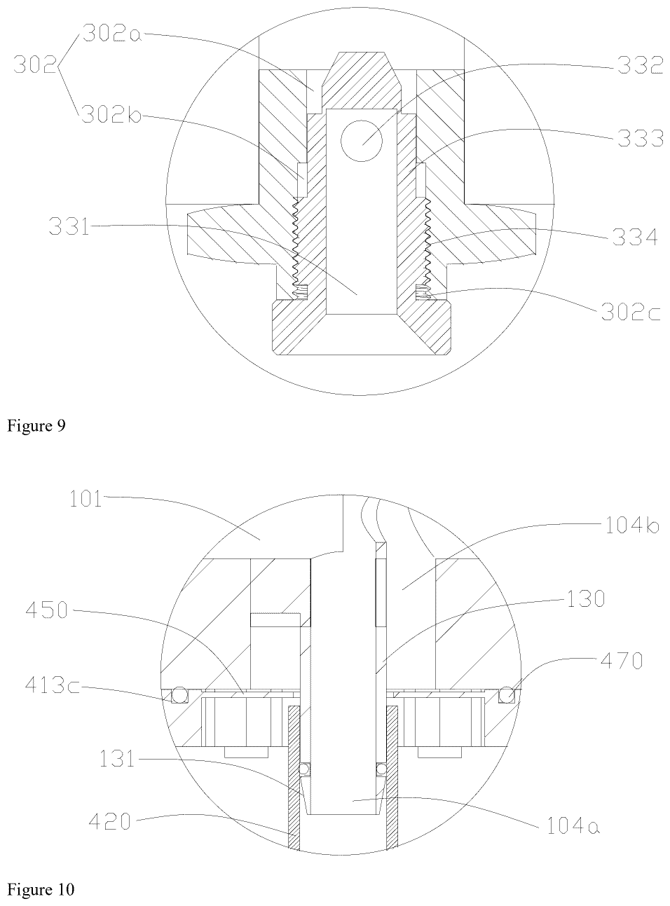

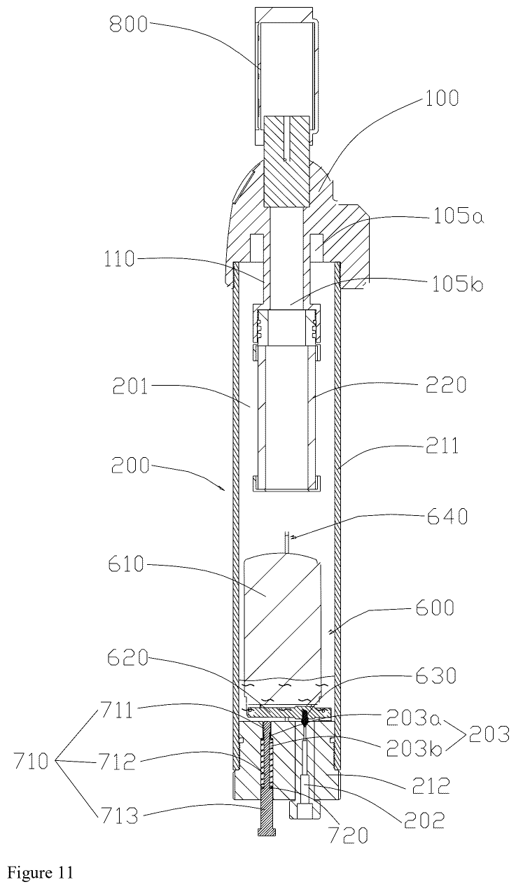

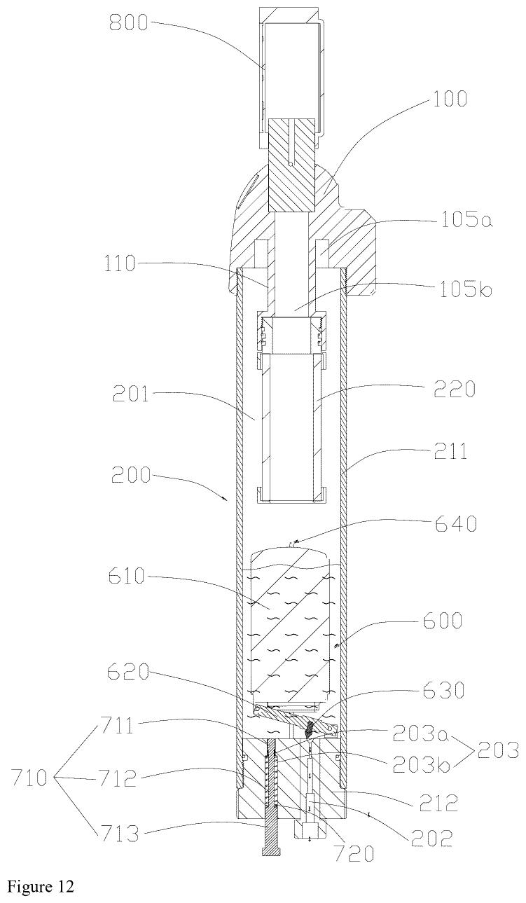

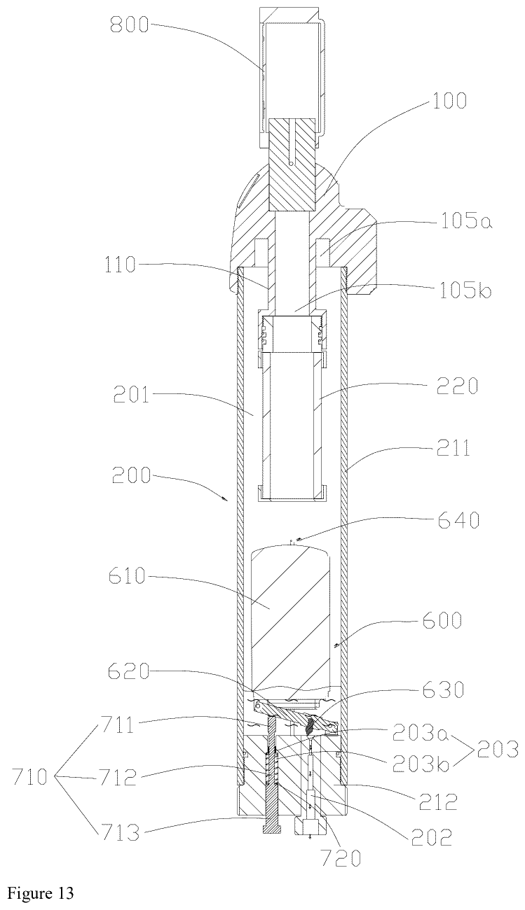

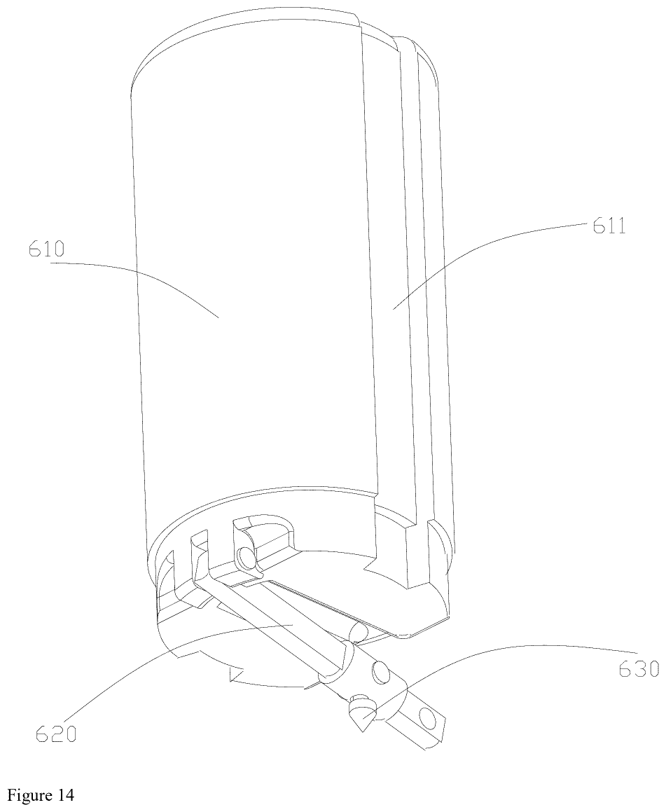

With reference to FIGS. 1 to 14, an air compressor filter including:

A housing 100, a first filtration component 200, a second filtration component 300, a silica filtration component 400, and an activated carbon filtration component 500. The housing 100 is provided with an airflow passage 101 and airflow inlet 102 and outlet 103 in communication with the airflow passage 101;

The first filtration component 200, the second filtration component 300, the silica filtration component 400, and the activated carbon filtration component 500 are sequentially connected to the housing 100 and communicate with the airflow passage 101. Airflow enters the airflow passage 101 through the airflow inlet 102 and flows through the first filtration component 200, the second filtration component 300, the silica filtration component 400, and the activated carbon filtration component 500, finally exiting through the airflow outlet 103;

In which, the silica filtration component 400 is provided with a holding space 401 to accommodate color-changing silica, and the surface of the silica filtration component 400 is equipped with several observation windows 411. The observation windows 411 allow the user to observe the color-changing silica inside the holding space 401.

Through the above structural arrangement, during use, the airflow enters the airflow passage 101 through the airflow inlet 102, then passes through the first filtration component 200, where it undergoes preliminary filtration to remove most of the water, solid dust, and other impurities in the airflow. The water and impurities are retained in the first filtration component 200, and the airflow exits, flowing through the airflow passage 101 into the second filtration component 300. After further filtration, most of the oil and remaining dust are removed, with the oil remaining in the second filtration component 300. The airflow exits and flows through the airflow passage 101 into the silica filtration component 400, where the color-changing silica in the silica filtration component 400 absorbs water, further removing water from the airflow. At the same time, the color-changing silica changes color as it absorbs water. The user can observe the color of the color-changing silica through the observation windows 411, allowing them to determine the saturation level of the color-changing silica. When the saturation level of the color-changing silica exceeds the preset value, the silica can be restored by heating or replaced, ensuring that the color-changing silica continues to adsorb the remaining moisture and indicate the moisture content in the airflow. This ensures that the moisture content of the airflow passing through the silica filtration component 400 is below the preset value. The airflow then exits the silica filtration component 400, flows through the airflow passage 101 into the activated carbon filtration component 500, where the activated carbon filter element inside the activated carbon filtration component 500 further adsorbs and filters the remaining oil vapors and odor molecules from the airflow. The clean airflow, filtered through multiple stages, exits into the airflow passage 101 and finally flows out through the airflow outlet 103.

In this embodiment, the silica filtration component 400 includes a silica filtration housing 410 and a gas guiding tube 420. The holding space 401 is provided inside the silica filtration housing 410. The housing 100 is equipped with a third inlet 104a and a third outlet 104b. The gas guiding tube 420 is connected to the housing 100, and the internal channel of the gas guiding tube 420 communicates with the third inlet 104a. The end of the gas guiding tube 420 extends to the bottom of the holding space 401. Through this arrangement, the gas guiding tube 420 directs the airflow to the bottom of the holding space 401, allowing the airflow to fully contact the color-changing silica inside the holding space 401, increasing the contact area between the airflow and the color-changing silica. This ensures that the color-changing silica effectively adsorbs moisture from the airflow, enhancing the moisture adsorption effect. Furthermore, since the airflow fully contacts the color-changing silica, the color change degree of the silica in all areas will be roughly the same, making the user's judgment of saturation through the color change more accurate and avoiding partial color changes in the silica being obscured by other uncolored parts, thus affecting the user's judgment. Exemplarily, the silica filtration housing 410 includes a third sleeve 412 and two third end components 413. The two third end components 413 are respectively connected to the upper and lower ends of the third sleeve 412. Specifically, both third end components 413 are provided with locking blocks 413a, and the inner wall of the third sleeve 412 is provided with a locking groove 412a and an insertion port 412b communicating with the locking groove 412a. After the locking blocks 413a are inserted into the insertion port 412b, the third end component 413 is rotated, causing the locking blocks 413a to be inserted into the locking groove 412a. At this point, the second threaded hole 413b on the third end component 413 aligns with the third threaded hole 412c on the third sleeve 412, and the first screw 460 is threaded into both the second threaded hole 413b and the third threaded hole 412c to fix the third end component 413 to the third sleeve 412. Exemplarily, the upper third end component 413 is connected to the housing 100 via a connecting component. The upper surface of the third end component 413 is provided with a sealing groove 413c, and the first sealing ring 470 is placed in the sealing groove 413c to seal against the lower surface of the housing 100, ensuring a seal between the silica filtration housing 410 and the housing 100. Exemplarily, a sealing ring is also present between the third sleeve 412 and the third end components 413 to ensure a seal between the third sleeve 412 and the third end components 413.

In this embodiment, the silica filtration component 400 also includes a first grid member 430, which is provided on the bottom wall of the silica filtration housing 410 and extends upward. The first grid member 430 is sleeved onto the end of the gas guiding tube 420. Through this arrangement, the tubular first grid member 430 is sleeved onto the end of the gas guiding tube 420 to block the color-changing silica and prevent it from entering the gas guiding tube 420, ensuring normal airflow. During use, the airflow enters the gas guiding tube 420 from the third inlet 104a, flows out from the end of the gas guiding tube 420, passes through the gap in the first grid member 430, flows into the holding space 401, passes over the surface of the color-changing silica, fully contacts the color-changing silica, and finally exits through the second outlet 104b.

In this embodiment, the sidewall of the end of the gas guiding tube 420 is provided with a ventilation hole 421, and the first grid member 430 covers the ventilation hole 421. Through this structure, the sidewall at the end of the gas guiding tube 420 has a runway-type ventilation hole 421, which extends along the length of the gas guiding tube 420. During use, the airflow passes through the gas guiding tube 420 and flows out through the ventilation hole 421. Moreover, the first grid member 430 covers the ventilation hole 421 to prevent the color-changing silica from entering the gas guiding tube 420 through the ventilation hole 421, ensuring smooth airflow.

In this embodiment, the silica filtration component 400 further includes a fixing component 440. The fixing component 440 is connected to the inner wall of the silica filtration housing 410 and is provided with a first mounting hole 441 at the center and through holes 442 surrounding the first mounting hole 441. The upper part of the outer wall of the gas guiding tube 420 is provided with a latch block 422. The gas guiding tube 420 passes through the first mounting hole 441, and the latch block 422 abuts against the lower surface of the fixing component 440. Through this arrangement, the gas guiding tube 420 passes through the first mounting hole 441, and the first mounting hole 441 restricts the radial movement of the gas guiding tube 420. The latch block 422 abuts the lower surface of the fixing component 440, which restricts the axial upward movement of the gas guiding tube 420, ensuring stable connection of the gas guiding tube 420 and extending the product's service life.

In this embodiment, the silica filtration component 400 further includes a second grid member 450. The second grid member 450 is provided at the opening of the silica filtration component 400 and is equipped with a second mounting hole 451. The housing 100 has a downwardly extending third mounting tube 130. The third inlet 104a is located at the third mounting tube 130, and the end of the third mounting tube 130 passes through the second mounting hole 451 and is inserted into the gas guiding tube 420. Through this arrangement, the second grid member 450 is provided at the opening of the silica filtration component 400, effectively covering the opening and preventing the color-changing silica from entering the airflow passage 101 with the airflow, ensuring the stability of the product. Additionally, the end of the third mounting tube 130 is inserted into the gas guiding tube 420, making it convenient for users to assemble the gas guiding tube 420, improving installation efficiency. Exemplarily, the end of the third mounting tube 130 is provided with a guiding bevel 131, which gradually increases the diameter from bottom to top. The guiding bevel 131 further facilitates the connection of the gas guiding tube 420 to the third mounting tube 130. Exemplarily, a first sealing ring 132 is sleeved on the outer wall of the end of the third mounting tube 130. When the end of the third mounting tube 130 is inserted into the gas guiding tube 420, the outer surface of the first sealing ring 132 abuts against the inner wall of the gas guiding tube 420, enhancing the airtightness between the third mounting tube 130 and the gas guiding tube 420.

In this embodiment, the first filtration component 200 includes a first filtration housing 210 and a first filter element 220. The housing 100 is provided with a first inlet 105a and a first outlet 105b. The first filtration housing 210 contains a first filtration chamber 201, and both the first inlet 105a and the first outlet 105b are in communication with the first filtration chamber 201. The first filter element 220 is arranged inside the first filtration chamber 201 and is connected to the first outlet 105b. Through this structure, during use, the airflow flows along the airflow passage 101 and enters the first filtration chamber 201 through the first inlet 105a. It passes through the first filter element 220, where the moisture, dust, and other solid impurities in the airflow are blocked by the first filter element 220 and remain in the first filtration chamber 201. The airflow finally exits through the first outlet 105b. Exemplarily, the first filtration housing 210 includes a first sleeve 211 and a first end component 212. The upper end of the first sleeve 211 is threadedly connected to the housing 100, and the first end component 212 is threadedly connected to the lower end of the first sleeve 211. A sealing ring is also present between the first sleeve 211 and the first end component 212 to achieve a seal between the first sleeve 211 and the first end component 212.

In this embodiment, the bottom wall of the first filtration housing 210 is provided with a water outlet passage 202. The air compressor filter further includes an automatic drainage component 600. The automatic drainage component 600 is arranged inside the first filtration chamber 201 and includes a buoyant member 610, a connecting rod 620, and a sealing plug 630 mounted on the connecting rod 620. The lower end of the connecting rod 620 is connected to the bottom wall of the first filtration housing 210, and the upper end of the connecting rod 620 is connected to the buoyant member 610. The sealing plug 630 covers the water outlet passage 202. When the liquid level in the first filtration chamber 201 exceeds the preset value, the buoyant member 610 moves upward under buoyancy, and the sealing plug 630 is detached from the water outlet passage 202, allowing water to flow out along the water outlet passage 202. Through this structure, during use, when the airflow passes through the first filter element 220, moisture quickly condenses into large water droplets on the surface of the first filter element 220. The large water droplets flow to the bottom of the first filtration chamber 201 under the force of gravity. When the liquid level value in the first filtration chamber 201 is lower than the pre-set value, the buoyant force acting on the buoyant member 610 is smaller, and under the force of gravity, it drives the sealing plug 630 to tightly cover the water outlet passage 202, ensuring the product's sealing. When the liquid level in the first filtration chamber 201 exceeds the preset value, the buoyant member 610 moves upward under buoyancy, driving the connecting rod 620 and sealing plug 630 to move. The sealing plug 630 is detached from the water outlet passage 202, allowing water to flow out along the water outlet passage 202, thus realizing automatic drainage.

In this embodiment, the diameter of the inlet end of the water outlet passage 202 is smaller than the diameter of the outlet end of the water outlet passage 202. Through this structure, the diameter of the water outlet passage 202 gradually increases from the inlet end to the outlet end, which reduces the water flow speed at the outlet end. This prevents the water flow from being too fast and ensures smooth, steady drainage of liquid. Additionally, it prevents gas blockage and impurities from clogging the system, thereby extending the product's service life.

In this embodiment, the buoyant member 610 is provided with sliding grooves 611 on both sides. The automatic drainage component 600 further includes a limiting component 640, which includes two vertical rods 641 and a horizontal rod 642. The lower ends of the vertical rods 641 are connected to the bottom wall of the first filtration housing 210, and the upper ends of the vertical rods 641 are connected to both ends of the horizontal rod 642. The vertical rods 641 are arranged inside the sliding grooves 611, and the horizontal rod 642 spans across the upper end of the buoyant member 610. Through this structure, when the buoyant member 610 rises or falls under the influence of buoyancy and/or gravity, the vertical rods 641 remain within the sliding grooves 611, thus limiting the movement direction of the buoyant member 610. This prevents the buoyant member 610 from swaying side to side or front to back. After the buoyant member 610 falls, it can stably drive the sealing plug 630 to tightly cover the water outlet passage 202, stabilizing the product structure.

In this embodiment, the air compressor filter also includes a manual release component 700. The manual release component 700 includes a driving push rod 710. The driving push rod 710 includes a first threaded portion 711 and a pressing portion 713. The bottom wall of the first filtration housing 210 is provided with a push rod hole 203, which includes an upper first threaded hole 203a and a lower rod hole 203b. The first threaded portion 711 is threaded into the first threaded hole 203a. When the first threaded portion 711 is detached from the first threaded hole 203a, the pressing portion 713 slides upward within the rod hole 203b under the drive of external force. The first threaded portion 711 pushes the connecting rod 620 to move upward, causing the sealing plug 630 to detach from the water outlet passage 202. Through this structure, during use, the driving push rod 710 is rotated to unscrew the first threaded portion 711 from the first threaded hole 203a. Then, the pressing portion 713 is pressed to slide upward, driving the upper end of the driving push rod 710 to abut against the connecting rod 620, moving the connecting rod 620 upward, which causes the sealing plug 630 to detach from the water outlet passage 202. At this point, water in the first filtration chamber 201 can flow out along the water outlet passage 202. This structure allows the user to manually drain the water, preventing liquid accumulation in the first filtration chamber 201 from corroding the first filtration housing 210.

In this embodiment, the manual release component 700 further includes a spring 720, and the driving push rod 710 also includes a connecting rod section 712. The diameter of the connecting rod section 712 is smaller than the diameters of the first threaded portion 711 and the pressing portion 713. The inner diameter of the first threaded hole 203a is smaller than the inner diameter of the rod hole 203b. The spring 720 is arranged inside the rod hole 203b and is sleeved onto the connecting rod section 712, with both ends of the spring 720 abutting against the upper wall of the rod hole 203b and the upper surface of the pressing portion 713. The spring 720 provides a downward and return movement tendency for the driving push rod 710. Through this structure, after the user manually drains the water using the manual release component 700, the user releases the driving push rod 710, and under the force of the spring 720, the driving push rod 710 moves downward and resets. The buoyant member 610 then moves downward under the influence of gravity, driving the sealing plug 630 to tightly cover the water outlet passage 202, ensuring the product's sealing integrity.

In this embodiment, the housing 100 is provided with a downwardly extending first mounting tube 110, and the first outlet 105b is located on the first mounting tube 110. The upper end of the first filter element 220 is threadedly connected to the end of the first mounting tube 110. With this arrangement, during use, the upper end of the first filter element 220 is threadedly connected to the end of the first mounting tube 110, which ensures that the first filter element 220 is stably connected to the housing 100, providing stability to the product's structure. Additionally, this design makes it easy for users to replace the first filter element 220, ensuring the filter's effectiveness.

In this embodiment, the second filtration component 300 includes a second filtration housing 310 and a second filter element 320. The housing 100 is provided with a second inlet 106a and a second outlet 106b. The second filtration housing 310 contains a second filtration chamber 301, and both the second inlet 106a and the second outlet 106b communicate with the second filtration chamber 301. The second filter element 320 is arranged inside the second filtration chamber 301 and is connected to the second inlet 106a. With this structure, during use, the second filter element 320 is placed into the second filtration chamber 301, with the second inlet 106a oriented towards the center of the second filter element 320. The airflow passes through the sidewall of the second filter element 320, filtering out liquid oil mist and fine dust particles. The airflow then enters the second filtration chamber 301 and exits through the second outlet 106b. Exemplarily, the second filtration housing 310 includes a second sleeve 311 and a second end component 312. The upper end of the second sleeve 311 is threadedly connected to the housing 100, and the second end component 312 is threadedly connected to the lower end of the second sleeve 311. Additionally, a sealing ring is provided between the second sleeve 311 and the second end component 312 to ensure a seal between these components.

In this embodiment, the housing 100 is provided with a downwardly extending second mounting tube 120, and the second inlet 106a is located on the second mounting tube 120. The upper end of the second filter element 320 is threadedly connected to the end of the second mounting tube 120. With this arrangement, the upper end of the second filter element 320 is threadedly connected to the end of the second mounting tube 120, which ensures that the second filter element 320 is stably connected to the second mounting tube 120. This design also makes it easy for users to replace the second filter element 320, thereby extending the product's service life.

In this embodiment, the second filtration component 300 further includes a drain plug 330. The bottom wall of the second filtration housing 310 is provided with a drainage passage 302, which includes a sealed passage 302a and a separated passage 302b. The diameter of the sealed passage 302a is smaller than the diameter of the separated passage 302b. The inner wall of the separated passage 302b is provided with a second internal thread 302c. The drain plug 330 has a blind hole 331 with an opening facing downward. The blind hole 331 is provided with a drainage port 332 that passes through the sidewall of the blind hole 331. The drain plug 330 includes a sealing portion 333 and a second threaded portion 334. The diameter of the sealing portion 333 is smaller than the diameter of the second threaded portion 334. The second threaded portion 334 is threaded into the second internal thread 302c, and the sealing portion 333 is inserted into or detached from the sealed passage 302a to cover or uncover the drainage port 332. With this arrangement, during use, the second threaded portion 334 is threaded into the second internal thread 302c, and the sealing portion 333 is inserted into the sealed passage 302a, which seals the drainage port 332 within the sealed passage 302a, effectively sealing it. When discharging the oil in the second filtration chamber 301, the user unscrews the drain plug 330, causing the drain plug 330 to move downward until the sealing portion 333 detaches from the sealed passage 302a. At this point, the drainage port 332 aligns with the sidewall of the separated passage 302b, and oil flows through the sealed passage 302a—drainage port 332—blind hole 331, allowing the user to manually drain the oil from the second filtration chamber 301, which is convenient for use.

In this embodiment, the activated carbon filtration component 500 includes an activated carbon filtration housing 510 and a fourth filter element 520. The housing 100 is provided with a fourth inlet 107a and a fourth outlet 107b. The activated carbon filtration housing 510 contains a fourth filtration chamber 501, and both the fourth inlet 107a and the fourth outlet 107b are in communication with the fourth filtration chamber 501. The fourth filter element 520 is arranged inside the fourth filtration chamber 501 and is connected to the fourth outlet 107b. With this structure, during use, the fourth filter element 520 is placed into the fourth filtration chamber 501 and connected to the fourth outlet 107b of the housing 100. The airflow enters the fourth filtration chamber 501 through the fourth inlet 107a, passes through the fourth filter element 520, and then exits through the fourth outlet 107b. The fourth filter element 520 is an activated carbon filter, which can effectively adsorb the remaining oil vapors in the airflow, further removing oil from the airflow, thus ensuring the product's filtration effect. Exemplarily, the activated carbon filtration housing 510 includes a fourth sleeve 511 and a fourth end component 512. The upper end of the fourth sleeve 511 is threadedly connected to the housing 100, and the fourth end component 512 is threadedly connected to the lower end of the fourth sleeve 511.

In this embodiment, the housing 100 is provided with a downwardly extending fourth mounting tube 140, and the fourth outlet 107b is located on the fourth mounting tube 140. The upper end of the fourth filter element 520 is threadedly connected to the end of the fourth mounting tube 140. With this arrangement, during use, the upper end of the fourth filter element 520 is threadedly connected to the end of the fourth mounting tube 140, ensuring a more stable connection of the product. Additionally, this design makes it more convenient for users to replace the fourth filter element 520.

In this embodiment, the fourth filter element 520 includes a filter section 521 and a connecting tube 522. The upper end of the connecting tube 522 is threadedly connected to the end of the fourth mounting tube 140, and the lower end of the connecting tube 522 is threadedly connected to the upper end of the filter section 521. With this arrangement, the connecting tube 522 is placed between the filter section 521 and the fourth mounting tube 140, increasing the distance between the filter section 521 and the inlet. This reduces the airflow speed through the filter section 521, allowing the activated carbon in the filter section 521 to more effectively adsorb the remaining oil vapors and odor molecules in the airflow, thus improving the filtration effect of the products.

In this embodiment, the air compressor filter further includes two pressure gauges 800, which are respectively connected to the front and rear ends of the housing 100. The pressure flow channels of the two pressure gauges 800 are connected to the airflow inlet 102 and the airflow outlet 103. With this arrangement, the user can measure the air pressure at the airflow inlet 102 and/or the airflow outlet 103 using the pressure gauges 800. This makes it easier for the user to adjust the air compressor's power, ensuring that the air pressure of the final output airflow meets the required specifications.

1. An air compressor filter, wherein comprising:
A housing, a first filtration component, a second filtration component, a silica filtration component, and an activated carbon filtration component, wherein the housing is provided with an airflow passage and an airflow inlet and an airflow outlet in communication with the airflow passage;
The first filtration component, the second filtration component, the silica filtration component, and the activated carbon filtration component are sequentially connected to the housing and communicate with the airflow passage, with airflow entering the airflow passage through the airflow inlet and passing through the first filtration component, the second filtration component, the silica filtration component, and the activated carbon filtration component, finally exiting through the airflow outlet;
wherein, the silica filtration component includes a holding space to accommodate color-changing silica, and the surface of the silica filtration component is provided with several observation windows, allowing the user to observe the color-changing silica within the holding space.

2. The air compressor filter according to claim 1, wherein the silica filtration component comprising a silica filtration housing and a gas guiding tube, the holding space being arranged inside the silica filtration housing, and the housing being provided with a third airflow inlet and a third airflow outlet, with the gas guiding tube being connected to the housing, and the internal passage of the gas guiding tube being in communication with the third airflow inlet, and the end of the gas guiding tube extending to the bottom of the holding space.

3. The air compressor filter according to claim 2, wherein the silica filtration component further comprising a first grid member, the first grid member being arranged on the bottom wall of the silica filtration housing and extending upwards, with the first grid member sleeved onto the end of the gas guiding tube.

4. The air compressor filter according to claim 3, wherein the sidewall of the end of the gas guiding tube being provided with a ventilation hole, and the first grid member covering the ventilation hole.

5. The air compressor filter according to claim 3, wherein the silica filtration component further comprising a fixing component, the fixing component being connected to the inner wall of the silica filtration housing, the fixing component being provided with a first mounting hole at the center and through holes surrounding the first mounting hole, with the upper part of the gas guiding tube being provided with a latch block, the gas guiding tube passing through the first mounting hole, and the latch block abutting the lower surface of the fixing component.

6. The air compressor filter according to claim 2, wherein the silica filtration component further comprising a second grid member, the second grid member being arranged at the opening of the silica filtration component, the second grid member being provided with a second mounting hole, with the housing being provided with a downwardly extending third mounting tube, with the third airflow inlet being arranged on the third mounting tube, and the end of the third mounting tube passing through the second mounting hole and being inserted into the gas guiding tube.

7. The air compressor filter according to claim 1, wherein the first filtration component comprising a first filtration housing and a first filter element, the housing being provided with a first airflow inlet and a first airflow outlet, the first filtration housing containing a first filtration chamber, with both the first airflow inlet and the first airflow outlet being in communication with the first filtration chamber, and the first filter element being arranged inside the first filtration chamber and connected to the first airflow outlet.

8. The air compressor filter according to claim 7, wherein the bottom wall of the first filtration housing being provided with a water outlet passage, and the air compressor filter further comprising an automatic drainage component, the automatic drainage component being arranged inside the first filtration chamber and comprising a buoyant member, a connecting rod, and a sealing plug arranged on the connecting rod, with the lower end of the connecting rod being connected to the bottom wall of the first filtration housing, the upper end of the connecting rod being connected to the buoyant member, and the sealing plug covering the water outlet passage, with the buoyant member moving upward under buoyancy when the liquid level inside the first filtration chamber exceeds the preset value, causing the sealing plug to detach from the water outlet passage and allowing water to flow out along the water outlet passage.

9. The air compressor filter according to claim 8, wherein the inlet end diameter of the water outlet passage being smaller than the outlet end diameter of the water outlet passage.

10. The air compressor filter according to claim 8, wherein the buoyant member being provided with sliding grooves on both sides, and the automatic drainage component further comprising a limiting component, the limiting component comprising two vertical rods and a horizontal rod, with the lower ends of the two vertical rods being connected to the bottom wall of the first filtration housing, and the upper ends of the vertical rods being connected to both ends of the horizontal rod, the vertical rods being arranged inside the sliding grooves, and the horizontal rod spanning across the upper end of the buoyant member.

11. The air compressor filter according to claim 8, wherein the air compressor filter further comprising a manual release component, the manual release component comprising a driving push rod, the driving push rod comprising a first threaded portion and a pressing portion, the bottom wall of the first filtration housing being provided with a push rod hole, the push rod hole comprising an upper first threaded hole and a lower rod hole, with the first threaded portion being threaded into the first threaded hole, and when the first threaded portion is detached from the first threaded hole, the pressing portion slides upward within the rod hole under external force, with the first threaded portion pushing the connecting rod upward, causing the sealing plug to detach from the water outlet passage.

12. The air compressor filter according to claim 11, wherein the manual release component further comprising a spring, the driving push rod further comprising a connecting rod section, the diameter of the connecting rod section being smaller than the diameters of the first threaded portion and the pressing portion, the inner diameter of the first threaded hole being smaller than the inner diameter of the rod hole, with the spring being arranged inside the rod hole and sleeved onto the connecting rod section, with both ends of the spring abutting against the upper wall of the rod hole and the upper surface of the pressing portion, and the spring providing a downward movement tendency for the driving push rod.

13. The air compressor filter according to claim 7, wherein the housing being provided with a downwardly extending first mounting tube, with the first airflow outlet being located on the first mounting tube, and the upper end of the first filter element being threadedly connected to the end of the first mounting tube.

14. The air compressor filter according to claim 1, wherein the second filtration component comprising a second filtration housing and a second filter element, the housing being provided with a second airflow inlet and a second airflow outlet, the second filtration housing containing a second filtration chamber, with both the second airflow inlet and the second airflow outlet being in communication with the second filtration chamber, and the second filter element being arranged inside the second filtration chamber and connected to the second airflow inlet.

15. The air compressor filter according to claim 14, wherein the housing being provided with a downwardly extending second mounting tube, with the second airflow inlet being located on the second mounting tube, and the upper end of the second filter element being threadedly connected to the end of the second mounting tube.

16. The air compressor filter according to claim 14, wherein the second filtration component further comprising a drain plug, the bottom wall of the second filtration housing being provided with a drainage passage, the drainage passage comprising a sealed passage and a separated passage, with the diameter of the sealed passage being smaller than the diameter of the separated passage, the inner wall of the separated passage being provided with a second internal thread, with the drain plug being provided with a downwardly opening blind hole, the blind hole being provided with a drainage port that passes through the sidewall of the blind hole, the drain plug comprising a sealing portion and a second threaded portion, the diameter of the sealing portion being smaller than the diameter of the second threaded portion, with the second threaded portion being threaded into the second internal thread, and the sealing portion being inserted into or detached from the sealed passage to cover or uncover the drainage port.

17. The air compressor filter according to claim 1, wherein the activated carbon filtration component comprising an activated carbon filtration housing and a fourth filter element, the housing being provided with a fourth airflow inlet and a fourth airflow outlet, the activated carbon filtration housing containing a fourth filtration chamber, with both the fourth airflow inlet and the fourth airflow outlet being in communication with the fourth filtration chamber, and the fourth filter element being arranged inside the fourth filtration chamber and connected to the fourth airflow outlet.

18. The air compressor filter according to claim 17, wherein the housing being provided with a downwardly extending fourth mounting tube, with the fourth airflow outlet being located on the fourth mounting tube, and the upper end of the fourth filter element being threadedly connected to the end of the fourth mounting tube.

19. The air compressor filter according to claim 18, wherein the fourth filter element comprising a filter section and a connecting tube, the upper end of the connecting tube being threadedly connected to the end of the fourth mounting tube, and the lower end of the connecting tube being threadedly connected to the upper end of the filter section.

20. The air compressor filter according to claim 1, wherein the air compressor filter further comprising two pressure gauges, with the two pressure gauges being respectively connected to the front and rear ends of the housing, and the testing airflow channels of the two pressure gauges being respectively in communication with the airflow inlet and the airflow outlet.
